(19) United States
(12) Patent Application Publication
(10) Pub. No.: US 2011/0208883 A1
(43) Pub. Date: Aug. 25, 2011

(54) MEMORY DEVICE AND METHOD FOR OPERATING AND CONTROLLING THE SAME

(76) Inventors: Jinyeong Moon, Gyeonggi-do (KR); Sang-Sic Yoon, Gyeonggi-do (KR)

(21) Appl. No.: 12/752,660

(22) Filed: Apr. 1, 2010

(30) Foreign Application Priority Data
Feb. 25, 2010 (KR) 10-2010-0017384

(51) Int. Cl. G06F 13/38; G06F 13/12; G06F 12/00

(52) U.S. Cl. 710/74; 710/71; 711/154; 711/E12.001

(57) ABSTRACT

A method for operating a memory device includes determining whether or not a data mask operation is to be performed and setting a mask setting value to a predetermined value, receiving a data packet, and extracting mask information from the data packet for masking data in response to the mask information and the mask setting value.

### CROSS-REFERENCE TO RELATED APPLICATIONS

The present application claims priority of Korean Patent Application No. 10-2010-0017384, filed on Feb. 25, 2010, which is incorporated herein by reference in its entirety.

### BACKGROUND OF THE INVENTION

Exemplary embodiments of the present invention relate to a memory device, and more particularly, to a data mask operation of a memory device.

A memory device may perform a data mask operation for blocking a data. When the data is masked, the masked data is not written in the memory device.

As memory devices shift from DDR (Double Data Rate) 3 memory devices to DDR 4 memory devices, a burst length increases up to 10. Here, a burst length denotes a length of a data transmission frame corresponding to the bit number of serial data input/output to/from a data I/O pin at a time. For example, when the burst length is set to 10, 10-bit data are input/output to/from the data I/O pin at a time. Among the input/output data, 8-bit data may be valid data and the remaining 2-bit data is for a data mask (DM), a data bus inversion (DBI), and a cyclic redundancy check (CRC).

As described above, in case that valid data and accompanying data are mixed in a data transmission frame, it is desirable that a memory device recognizes whether or not information for a data mask is included in the data transmission frame.

### SUMMARY OF THE INVENTION

An embodiment of the present invention is directed to a method for recognizing whether or not data mask information is included in a data transmission frame.

In accordance with an embodiment of the present invention, a method for operating a memory device, includes: determining whether or not a data mask operation is to be performed and setting a mask setting value to a predetermined value; receiving a data packet; and extracting mask information from the data packet for masking data in response to the mask information and the mask setting value.

In accordance with another embodiment of the present invention, a method for controlling a memory device, includes: sending a mask setting value to determine whether or not a data mask operation is to be performed; sending a write command; and determining whether or not a data packet includes mask information in response to the mask setting value, and sending the data packet corresponding to the write command.

In accordance with further another embodiment of the present invention, a memory device includes: a memory core region configured to store data; a setting value storing unit configured to store a mask setting value; a data input unit configured to receive a data packet; and a mask executing unit configured to extract mask information from the data packet to block masked data from being written in the memory core region in response to the mask setting value.

### BRIEF DESCRIPTION OF THE DRAWINGS

FIG. 1 illustrates a block diagram of a memory device in accordance with an embodiment of the present invention.

FIG. 2 illustrates a block diagram of a mask extracting unit shown in FIG. 1.

FIG. 3 illustrates a block diagram of a unit masker included in a masking unit shown in FIG. 1.

### DESCRIPTION OF SPECIFIC EMBODIMENTS

Exemplary embodiments of the present invention are described below in more detail with reference to the accompanying drawings. The present invention may, however, be embodied in different forms and should not be constructed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various drawing figures and embodiments of the present invention.

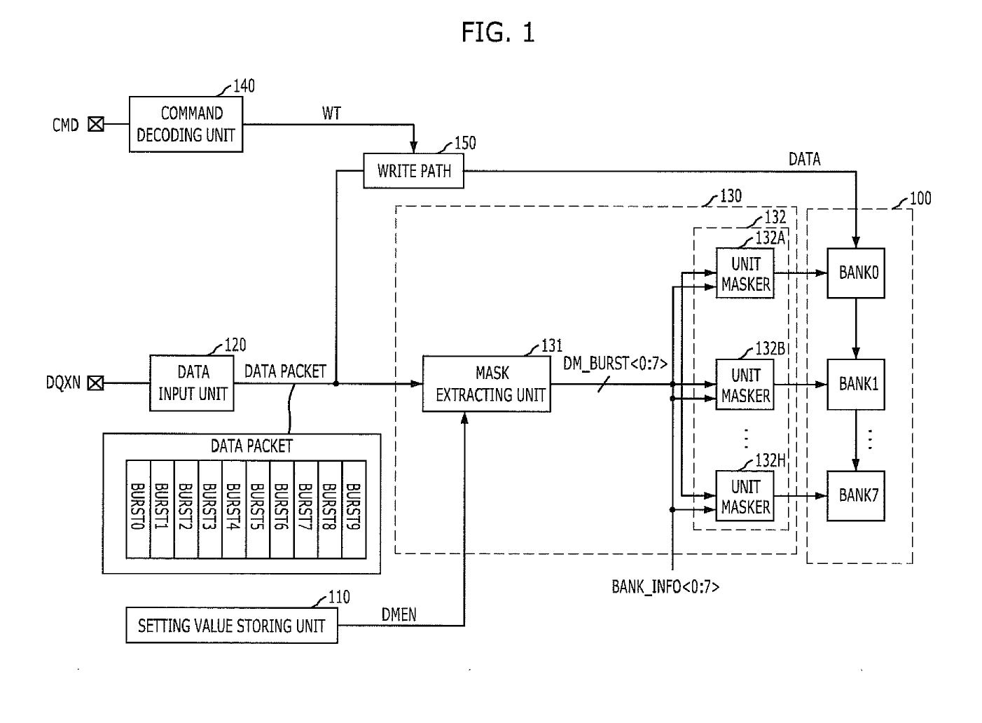

FIG. 1 illustrates a block diagram of a memory device in accordance with an embodiment of the present invention.

As shown, the memory device includes a memory core region 100, a setting value storing unit 110, a data input unit 120, and a mask executing unit 130.

The memory core region 100 is configured to store data.

The setting value storing unit 110 is configured to store a mask setting value DMEN set in a setting stage of the memory device. Here, the setting stage includes a stage for setting a mode register setting (MRS) and a stage for initializing the memory device. After determining whether or not a data mask operation is to be performed, the setting value storing unit 110 stores the mask setting value DMEN, which may vary based on particular circumstances. The setting value storing unit 110 may be implemented with an MRS register for storing MRS values.

The data input unit 120 is configured to receive a data packet input from data pads DQXN. In FIG. 1, “XN” represents that the number of the data pads DQ is N, N being the natural number. Serial data whose bit number corresponds to a burst length BL are input to each of N data pads DQ. In FIG. 1, “BURST0” represents first data of the serial data input from the N data pads DQ, and “BURST9” represents tenth data of the serial data input from the N data pads DQ. According to an example, each of data BURST0 to BURST9 includes 10 bits of data.

The mask executing unit 130 is configured to extract mask information DM_BURST<0:7> from the data packet in order to block masked data from being written in the memory core region 100. Here, whether or not the mask executing unit 130 performs the mask operation is determined in response to the mask setting value DMEN.

In detail, the mask executing unit 130 includes a mask extracting unit 131 and a masking unit 132. The mask extracting unit 131 is configured to extract the mask information DM_BURST<0:7> from the data packet in response to the mask setting value DMEN. The masking unit 132 is configured to block the masked data from being written in the memory core region 100 in response to the extracted mask information DM_BURST<0:7> and bank information BANK_INFO<0:7>.

When the mask setting value DMEN is set to a logic high level in order to perform the mask operation, the mask information DM_BURST<0:7> is included in the data packet. In the data packet, the place where the mask information DM_BURST<0:7> is included may differ according to an architecture of the memory device.

In an exemplary embodiment, the mask information DM_BURST<0:7> may be included in any of the data BURST0 to BURST9 of the data packet. For example, the data BURST0 to BURST7 of the data packet may have normal valid data, the data BURST8 may have CRC data, and the data BURST9 may have the mask information DM_BURST<0:7>. In another exemplary embodiment, a dedicated data pad DQ for receiving the mask information DM_BURST<0:7> may be provided. For example, when 9 data pads DQ are provided, 8 data pads DQ may receive normal valid data, and the remaining one data pad DQ may receive the mask information DM_BURST<0:7>. Thus, the mask extracting unit 131 can extract the mask information DM_BURST<0:7> from the data packet.

The masking unit 132 includes a plurality of unit maskers 132A to 132H, whose number corresponds to the number of banks provided in the memory core region 100. The unit maskers 132A to 132H are configured to block the masked data from being written in the memory core region 100 in response to the mask information DM_BURST<0:7> and the bank information BANK_INFO<0:7>. As a result, only data which are not masked are written in the memory core region 100 in response to the mask information DM_BURST<0:7>.

The memory device further comprises a command decoding unit 140 configured to decode an input command. The input command may include a write command WT.

A write path unit 150 shown in FIG. 1 shows a path for transmitting the valid data included in the data packet input from the data input unit 120 to the memory core region 100. The write path unit 150 transmits the valid data to the memory core region 100 in response to the write command WT.

In accordance with the embodiment, whether or not the data mask operation is performed is determined by setting the memory device based on the environment with which the memory device of FIG. 1 is used. Accordingly, during the operation of the memory device, separate information indicating whether or not the mask information DM_BURST<0:7> is not necessary. Accordingly, an architecture and operation of a memory controller for controlling the memory device can be simplified.

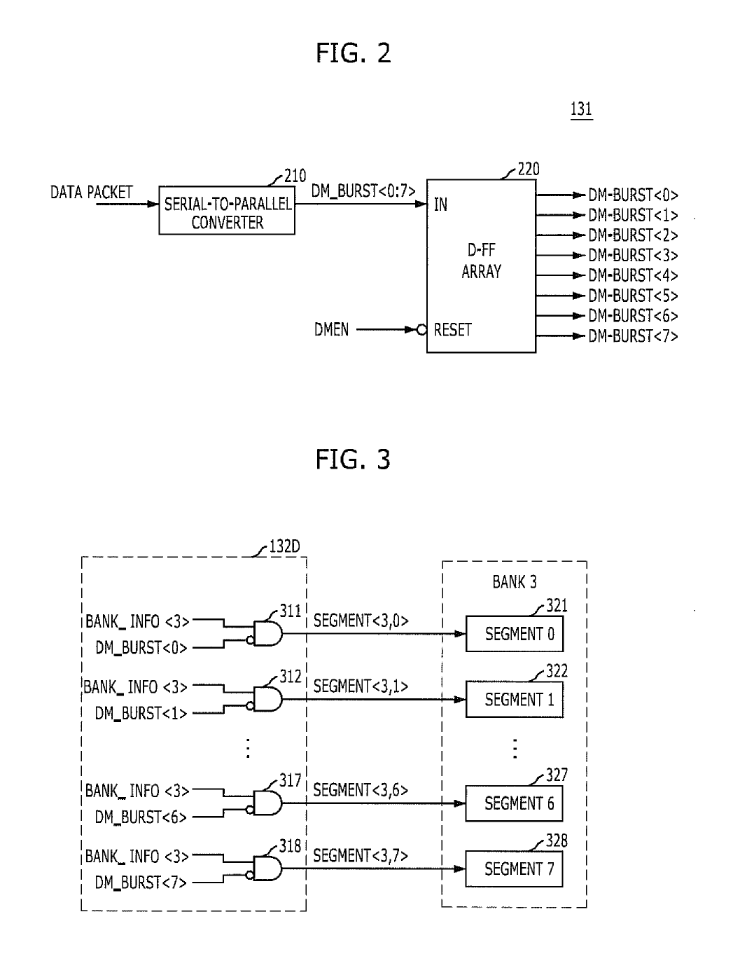

FIG. 2 illustrates a block diagram of the mask extracting unit 131 shown in FIG. 1.

Depending on the location where the mask information DM_BURST<0:7> is included in the data packet, the construction of the mask extracting unit 131 may differ. FIG. 2 shows the mask extracting unit 131 for a case that a dedicated data pad DQ for receiving the mask information DM_BURST<0:7> is provided. Assuming that 9 data pads DQ are provided, and, among them, the eighth data pad DQ is the dedicated data pad DQ for receiving the mask information DM_BURST<0:7>, an operation of the mask extracting unit 131 extracting the mask information DM_BURST<0:7> from the data packet will be explained below in detail.

Referring to FIG. 2, the mask extracting unit 131 includes a serial-to-parallel converter 210, and a D flip-flop array 220.

The serial-to-parallel converter 210 is configured to receive the mask information DM_BURST<0:7> input from the dedicated data pad DQ in series through the data input unit 120 to convert and output the mask information DM_BURST<0:7> in parallel.

The D flip-flop array 220 is configured receive and store the mask information DM_BURST<0:7>, which are aligned in parallel, in response to the mask setting value DMEN. When the mask setting value DMEN is set to a logic high level, the D flip-flop array 220 normally operates. When the mask setting value DMEN is set to a logic low level, the D flip-flop array 220 deactivates and outputs all bits of the mask information DM_BURST<0:7> at a logic low level. Accordingly, when the mask setting value DMEN is set to a logic low level, no data is masked.

FIG. 3 illustrates a block diagram of a fourth unit masker 132D included in the masking unit 132 shown in FIG. 1.

Since the fourth unit masker 132D for masking data input to a fourth bank BANK3 has substantially the same structure as those of the other unit maskers 132A, 132B, 132C, 132E, 132F, 132G and 132H for masking data input to banks BANK0 to BANK2 and BANK4 to BANK7, their detailed description will be omitted for conciseness.

As shown, the fourth unit masker 132D comprises a plurality of AND gates 311 to 318, each of which is configured to activate a corresponding one of segments 321 to 328 of the fourth bank BANK3 of the memory core region 100 based on the mask information DM_BURST<0:7> and a corresponding bank information, i.e., a fourth bank information BANK_INFO<3>.

When the fourth bank information BANK_INFO<3> is activated to a logic high level and a first mask information DM_BURST<0> is deactivated to a logic low level, a first AND gate 311 activates and outputs a first segment activation signal SEGMENT<3, 0> of a logic high level to a first segment 321. As a result, the first segment 321 can normally perform a write operation.

When the fourth bank information BANK_INFO<3> is deactivated to a logic low level or the first mask information DM_BURST<0> is activated to a logic high level, the first AND gate 311 deactivates and outputs the first segment activation signal SEGMENT<3, 0> of a logic low level to the first segment 321. As a result, the first segment 321 is deactivated so as not to perform the write operation even if data are input.

Since operations of the other AND gates 312 to 318 and the other segments 322 to 328 are similar to that of the first AND gate 311 and the first segment 321, their detailed description will be omitted for conciseness.

Referring back to FIG. 1, an operation of the memory device in accordance with an embodiment of the present invention will be explained hereinafter.

First, whether or not a data mask operation is to be performed is determined. Such determination is performed in a stage for setting a mode register setting (MRS) or a stage for initializing the memory device. After the determination of whether or not a data mask operation is to be performed is made, the mask setting value DMEN is stored according to the determination.

During a write operation of the memory device, a data packet is input in response to a write command WT. When the mask setting value DMEN is set to a logic high level in order to perform the data mask operation, the mask information DM_BURST<0:7> is included in the data packet. Accordingly, the memory device extracts the mask information DM_BURST<0:7> from the data packet to mask data input to a bank in response to the extracted mask information DM_BURST<0:7>. When the mask setting value DMEN is set to a logic low level so as not to perform the data mask operation, the data input to the bank are not masked.

Hereinafter, an operation of a memory controller for controlling the memory device in accordance with an embodiment of the present invention will be explained.

The memory controller transmits a mask setting value DMEN for determining whether or not a data mask operation is performed for the memory device. This can be achieved in a stage for setting a mode register setting (MRS) or a stage for initializing the memory device.

After transmitting the mask setting value DMEN, the memory controller sends a write command WT and a data packet corresponding to the write command WT to the memory device.

When the mask setting value OMEN is set to a logic high level in order to perform the data mask operation, the memory controller sends a data packet that includes the mask information DM_BURST<0:7>. On the contrary, when the mask setting value DMEN is set to a logic low level so as not to perform the data mask operation, the memory controller sends a data packet that does not include the mask information DM_BURST<0:7>. In the case that the data mask operation is not performed, the memory controller may send a data packet that includes another information such as a data bus inversion (DBI) and a cyclic redundancy check (CRC) instead of mask information DM_BURST<0:7>.

In accordance with the exemplary embodiments of the present invention, a memory device can determine whether or not a data mask operation is to be performed, i.e., whether or not mask information is included in a data packet, at a setting stage of the memory device.

In accordance with the exemplary embodiments of the present invention, since a determination of whether or not a data mask operation is performed depends on a variable that depends on different circumstances, separate information indicating whether or not mask information is included in a data packet is not required during an operation of a memory device. Accordingly, an architecture and operation of a memory controller for controlling the memory device can be simplified.

While the present invention has been described with respect to specific embodiments, it will be apparent to those skilled in the art that various changes and modifications may be made without departing from the spirit and scope of the present invention as defined by the following claims.

What is claimed is:

1. A method for operating a memory device, comprising:
determining whether or not a data mask operation is to be performed and setting a mask setting value to a predetermined value;
receiving a data packet; and
extracting mask information from the data packet for masking data in response to the mask information and the mask setting value.

2. The method of claim 1, wherein the setting of the mask setting value to the predetermined value comprises setting a mode register setting (MRS) of the memory device.

3. The method of claim 1, wherein the setting of the mask setting value to the predetermined value is performed at a stage for initializing the memory device.

4. A method for controlling a memory device, comprising:
sending a mask setting value to determine whether or not a data mask operation is to be performed;
sending a write command; and
determining whether or not a data packet includes mask information in response to the mask setting value, and sending the data packet corresponding to the write command.

5. The method of claim 4, wherein the sending of the mask setting value is performed at a stage for setting a mode register setting (MRS) of the memory device.

6. The method of claim 4, wherein the sending of the mask setting value is performed at a stage for initializing the memory device.

7. A memory device, comprising:
a memory core region configured to store data;
a setting value storing unit configured to store a mask setting value;
a data input unit configured to transfer a data packet input from data pads; and
a mask executing unit configured to extract mask information from the transferred data packet to block data from being written in the memory core region in response to the mask setting value.

8. The memory device of claim 7, wherein the mask setting value is set by a mode register setting (MRS).

9. The memory device of claim 7, wherein the mask setting value is set in a stage for initializing the memory device.

10. The memory device of claim 7, wherein the mask executing unit comprises:
a mask extracting unit configured to extract the mask information from the transferred data packet in response to the mask setting value; and
a masking unit configured to block the data from being written in the memory core region in response to the extracted mask information.

11. The memory device of claim 10, wherein the mask extracting unit deactivates a plurality of signals for the mask information when the mask setting value is set not to perform a data mask operation.

12. The memory device of claim 10, wherein the mask extracting unit comprises:
a serial-to-parallel converter configured to receive the mask information input in series from the data input unit to convert and output the mask information in parallel; and
a flip-flop array configured to receive and store the mask information, which are aligned in parallel, in response to the mask setting value.

13. The memory device of claim 12, wherein the flip-flop array deactivates and outputs a plurality of signals for the mask information at a second logic level to disable a data mask operation.

14. The memory device of claim 10, wherein the masking unit deactivates a corresponding segment in the memory core region and writes the data in response to the extracted mask information.

15. The memory device of claim 10, wherein the masking unit comprises a plurality of unit maskers, where the number of the plurality of unit maskers corresponds to the number of banks provided in the memory core region.

16. The memory device of claim 15, wherein each unit masker comprises a plurality of AND gates configured to activate a corresponding one of segments included in the banks of the memory core region based on the extracted mask information.

17. The memory device of claim 7, further comprising:
a write path unit configured to transmit valid data included in the data packet input from the data input unit to the memory core region in response to a write command.
